(19) United States
(12) Patent Application Publication
(10) Pub. No.: US 2011/0122527 A1
(43) Pub. Date: May 26, 2011

(54) Storing and Locating a Self-Describing Storage Cartridge

(75) Inventors: Arnon Amir, Saratoga, CA (US); Edwin R. Childers, Tucson, AZ (US); Wayne I. Imaino, San Jose, CA (US); Winfried W. Wilcke, Los Altos Hills, CA (US)

(73) Assignee: INTERNATIONAL BUSINESS MACHINES CORPORATION, Armonk, NY (US)

(21) Appl. No.: 12/626,070

(22) Filed: Nov. 25, 2009

(51) Int. Cl. G11B 15/68

(52) U.S. Cl. 360/92.1; G9B/15.135

(57) ABSTRACT

Embodiments of the invention relate to storing and locating a self-describing storage cartridge. An aspect of the invention includes a system for storing and locating a self-describing storage cartridge. The system includes a storage cartridge. The storage cartridge includes a first storage module configured to store data objects. The storage cartridge further includes a second storage module configured to store an index describing the data objects stored on the first storage module. The storage cartridge further includes a connector coupled to the second storage module and configured to provide an external device with access to the second storage module.

### BACKGROUND

1. Field of the Invention

Embodiments of the invention relate to the field of storage cartridges. In particular, embodiments of the invention relate to storing and locating a self-describing storage cartridge.

2. Background of the Invention

Storage cartridges are a form of removable storage that store data for rapid access, long term data retention, and storage backup. Storage cartridges are generally first loaded into a tape drive to access the data stored in the storage cartridge. A tape drive is a device capable of accessing the data stored in the cartridge, write and/or read data from the cartridge and transfer the data to a computer, a host device, or other devices.

Storage management systems using storage cartridges are scalable, so that more cartridges may be added without adding more drives. Storage cartridges are also portable, so that they can move to and from storage sites and storage systems. Storage cartridges may have various physical cartridge architectures, including optical and magnetic media.

Storage cartridges may be stored remotely from a storage system. Storage cartridges are typically physically stored in repositories, such as storage libraries, storage containers, and storage shelves. Storage libraries are used to access, write and archive data stored on the storage cartridges. The storage libraries are typically robot operated and include storage cartridge drive devices configured to read and write data to and from the storage cartridges. For example, Automated Tape Libraries (ATL) are used to store and manage magnetic tape cartridges.

Data stored on a storage cartridge are generally managed by a storage system. Storage systems use storage management software to manage identification of a storage cartridge to locate a specific data subset. A storage cartridge may be identified with bar codes and labels, Radio Frequency Identification (RFID) and other means. The storage system may also manage and track location of storage cartridges within a storage library. However, access to data stored on storage cartridges can not be provided to the storage system without the storage cartridge being physically mounted in a drive.

### BRIEF SUMMARY

Embodiments of the invention relate to storing and locating a self-describing storage cartridge. An aspect of the invention includes a system for storing and locating a self-describing storage cartridge. The system includes a storage cartridge. The storage cartridge includes a first storage module configured to store data objects. The storage cartridge further includes a second storage module configured to store an index describing the data objects stored on the first storage module. The storage cartridge further includes a connector coupled to the second storage module and configured to provide an external device with access to the second storage module.

Another aspect of the invention includes a method for storing and locating a self-describing storage cartridge. The method includes storing data objects on a first storage module of a storage cartridge. The method further includes storing an index on a second storage module describing the data objects stored on the first storage module. The method further includes providing a remote device with access to the second storage module.

These illustrative embodiments are mentioned not to limit or define the invention, but to provide examples to aid understanding thereof. Illustrative embodiments are discussed in the Detailed Description, and further description of the disclosure is provided there. Advantages offered by various embodiments of this disclosure may be further understood by examining this specification.

### BRIEF DESCRIPTION OF THE SEVERAL VIEWS OF THE DRAWINGS

These and other features, aspects, and advantages of the present invention are better understood when the following Detailed Description is read with reference to the accompanying drawings, wherein:

FIG. 1 illustrates a self-describing storage cartridge, according to one embodiment;

FIG. 2 illustrates a flow chart of a method for self-describing the data content stored on a storage cartridge, according to one embodiment;

FIG. 3 illustrates a self-describing storage cartridge with a communication module, according to one embodiment;

FIG. 4 illustrates a self-describing storage cartridge with a notification module, according to one embodiment;

FIG. 5 illustrates a storage cartridge repository for storing a self-describing storage cartridge, according to one embodiment;

FIG. 6 illustrates a storage cartridge repository with a communication module for storing a self-describing storage cartridge; and

FIG. 7 illustrates a storage cartridge repository with a power module for storing a self-describing storage cartridge, according to one embodiment.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc. The description may disclose several preferred embodiments for file management in a shared file system. While the following description will be described in terms of such language for clarity and placing the invention in context, it should be kept in mind that the teachings herein may have broad application to all types of systems, devices and applications.

Embodiments of the invention relate to storing and locating a self-describing storage cartridge. There is need to reduce the cost of long term storage as the amount of digital media grows such that storage cartridges can be stored without the use of an automated robot operated library. However, knowing the location of storage cartridges or knowing the content stored on a storage cartridge is not possible with traditional storage cartridges without the use of an automated robot operated library. Furthermore, maintaining a catalogue on a server for long period of time (e.g., 10-100 years) is challenging as information technology (IT) changes quickly and databases need to be maintained and migrated to new systems as technology evolves. Moreover, whenever a storage cartridge is misplaced, it is difficult to locate the misplaced storage cartridge or know what data is stored on a storage cartridge with a missing label.

A self-describing storage cartridge contains a nonvolatile memory module for storing an index which describes the contents of the data objects stored on the storage cartridge. The invention further provides a repository for storing and locating the self-describing storage cartridges. The storage cartridge repository communicates with the self-describing storage cartridge and remote devices to provide the remote devices with access to the index containing indices and descriptors of the storage cartridge's data contents. The storage cartridge repository also has the ability to identify the location of the storage cartridge placed in any location in the repository or moved between archive locations without being lost or need to be placed in robot operated library to assist with the handling of storage cartridges.

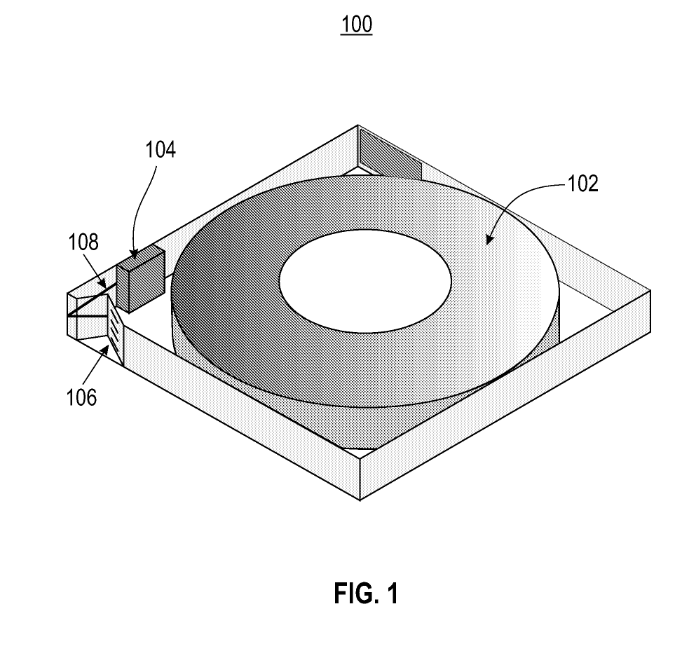

FIG. 1 illustrates a self-describing storage cartridge 100, according to one embodiment. The storage cartridge 100 includes a first storage module 102. The first storage module 102 is configured to store a plurality of data objects. The storage cartridge 100 further includes a second storage module 104. The second storage module 104 is configured to store a file and data index of the plurality of data objects stored on the first storage module.

The storage cartridge system 100 further includes a connector 106. The connector 106 is coupled to the second storage module 104 over a communication bus 108. The connector 106 is configured to write and read the file and data index on the second storage module 104. The connector 106 is further configured to provide access to the file and data index stored on the second storage module 104.

The connector 106 is a general electrical connector such as a conductive device for joining electrical circuits, according to a preferred embodiment. The connector 106 uses low contact resistance to provide conductivity. The connector 106 may be insulated to provide resistance to vibration, water, oil, and pressure, according to one embodiment. The connector 106 is configured to facilitate mating/unmating with a connector in a drive. The connector writes information to the file and data index stored on the second storage module 106 when the storage cartridge 100 is loaded in a drive and the plurality of data objects are being written to the first storage module 102. File system software (or application software) which writes the plurality of data objects (data content) to the first storage module 102 also writes the file and data index to the second storage module 104.

The connector 106 is embodied in a capacitive communication module, according to another embodiment. The connector 106 embodied in a capacitive communication module provides for contact between the storage cartridge 100 and other devices, including drives. The connector 106 embodied in a capacitive communication module can provide fast bidirectional communication to read and write the file and data index information stored on the second storage module 104.

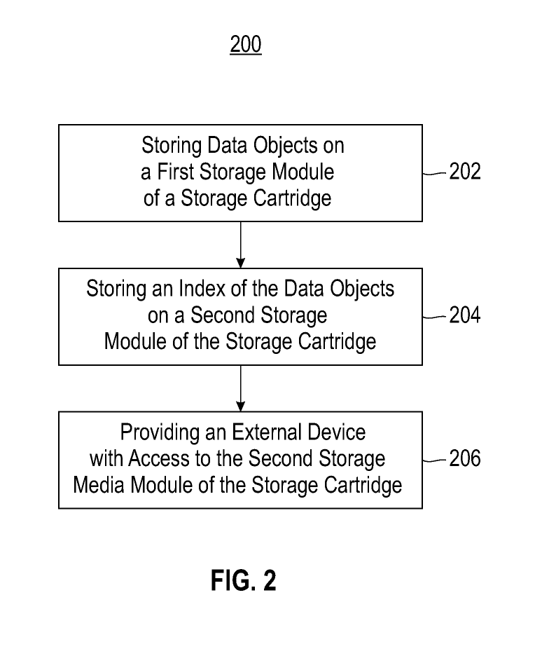

FIG. 2 illustrates a flow chart of a method 200 for self-describing the data content stored on a storage cartridge, according to one embodiment. A plurality of data objects are stored on a first storage module 102 of a storage cartridge 100 (step 202). The storage cartridge 100 stores a file and data index describing the plurality of data objects on a second storage module 104 (step 204). The connector 106 provides a plurality of devices with access to the second storage module 104 (step 206).

The embodiments of the invention may be implemented using various designed storage cartridge devices. The storage cartridges may include a magnetic storage device, an optical storage device, or a holographic storage device. Optical storage devices store data on an optically readable medium. Optical storage devices store data by making marks in a pattern that can be read back with the aid of light, including laser light. Magnetic storage devices use different patterns of magnetization in a magnetic material to store data. Magnetic storage is accessed using at least one read/write head. The data stored on the magnetic and optical storage devices can include audio data, visual data, application data and other data file formats. Holographic storage devices record data throughout the volume of the medium and are capable of recording multiple data images in the same area of the media using light at different angles.

The second storage module 104 comprises nonvolatile memory, according to the preferred embodiment. Nonvolatile memory is memory that can retain the stored information even when the memory is not powered. The file and data index on the second storage module 104 comprising nonvolatile memory can be accessed with or without loading the storage cartridge 100 into a drive.

The second storage module 104 stores indices and descriptors of the plurality of data objects stored on the first memory module 102 in a file and data index. The indices and descriptors may include various indices and descriptors for describing the plurality of data objects stored on the first memory module 102 in the file and data index. For example, the indices and descriptors may includes a file allocation table, a directory index, file metadata, and a file system index, various file-content indices, file previews, and key textual descriptions. The various indices and descriptors provide for search and browsing capabilities of the data content stored on the first memory module 102 described on the file and data index. The indices and descriptors also support previews of digital content such as thumbnails and video proxies, storyboards, transcripts, Material Exchange Format (MXF) information, EXIF information, and MPEG-7 metadata.

According to the preferred embodiment, the second storage module 104 uses a FAT16 standard as the format for storing the file and data index. When the second storage module 104 is accessed by a remote device, such as a computer, the file and data index provides for directory contents and file names to be viewed as if they are the actual files because of the standard way the file and data index is stored. The directory structure described on the second storage module 104 is an XML file, according to the preferred embodiment.

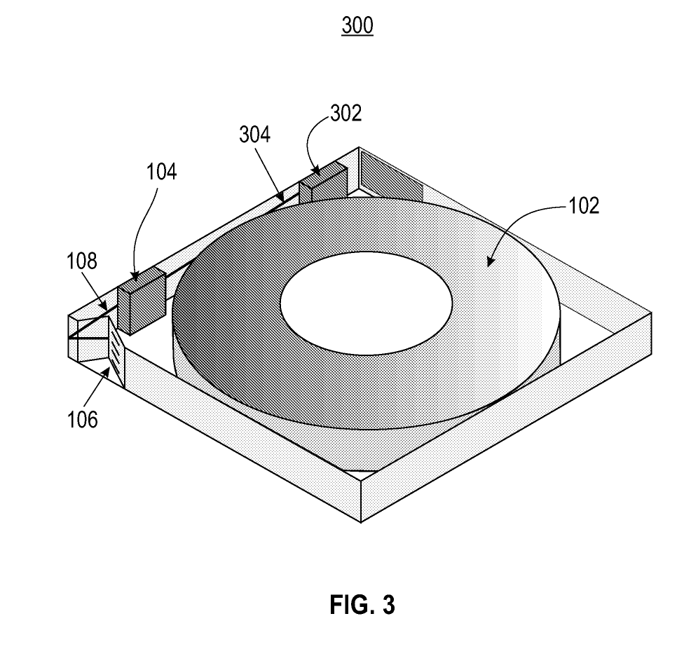

FIG. 3 illustrates a self-describing storage cartridge with a communication module, according to the preferred embodiment. The communication module 302 is coupled to the second storage module 104 of storage cartridge 300 over communication bus 304. The communication module 302 is configured to provide a plurality of devices with remote access to the second storage module 104 without a need to load the storage cartridge 300 into a drive. The communication module 302 as coupled to the second storage module 104 can provide power to second storage module 104 to enable operation of the second storage module without the storage cartridge 300 being loaded in a drive. The communication module 104 thereby allows a plurality of remote devices to access the file and data index stored on the second storage module 104 without the storage cartridge 300 being loaded in a drive.

The communication module 302 is embodied in a radio-frequency communication module, according to the preferred embodiment. Radio frequency (RF) provides communication when an alternating current (AC) is applied to an RF circuit and an electromagnetic (EM) field is generated suitable for wireless communications. When an RF current is supplied to a connector, the RF current gives rise to an electromagnetic field that propagates through space.

The communication module 302 is embodied in a wireless local area network communication module, according to another embodiment. A wireless local area network (WLAN) uses spread-spectrum or Orthogonal Frequency-Division Multiplexing (OFDM) modulation technology to enable communication between devices in a limited area. A WLAN communication module provides the ability to move around within a WLAN coverage area and still be connected to the network. WLAN allows users to access the file and data index stored on the second storage module 104 from within the WLAN network.

The communication module 302 is embodied in a Bluetooth communication module, according to another embodiment. Bluetooth is a communication protocol for a short-range communication between devices. Bluetooth allows users to connect to a wide range of devices at one time without cables, and without actively initiating the connection. Bluetooth provides connectivity for close range devices. The Bluetooth communication module can provide remote and wireless access to the second storage media module 104 storing the file and data index of the plurality of data objects on the first storage module.

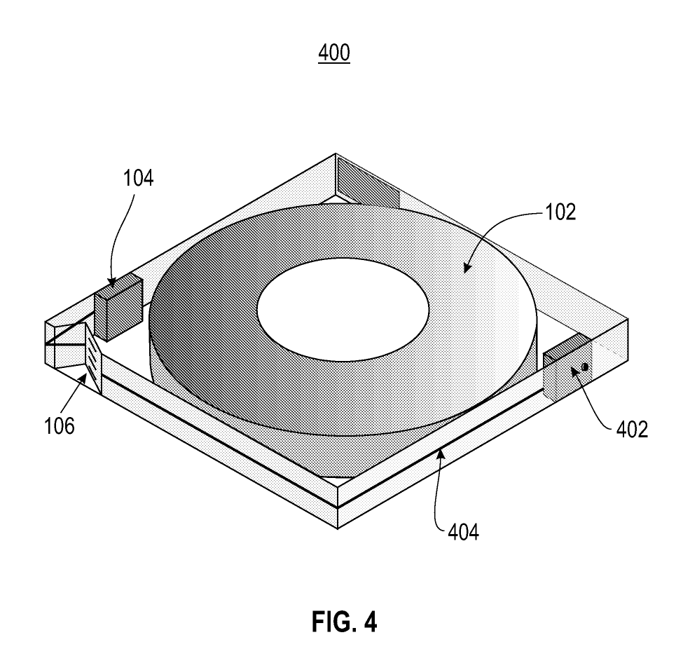

FIG. 4 illustrates a self-describing storage cartridge 400 with a notification module 402. The notification module 402 is coupled to the storage cartridge 400 and further coupled to the connector 106. The notification module 402 is configured to produce an audible signal, according to a preferred embodiment. An audible signal includes a beep sound or a sequence of beeps or sounds on the storage cartridge 400, according to one embodiment. The notification module 402 is configured to produce a visual signal, according to another embodiment. A visual signal may include a turning on or signaling of a light(s) on the storage cartridge 400, according to one embodiment. The notification module 402 is configured to produce a radio frequency signal, according to another embodiment. The radio frequency signal may include a plurality of electromagnetic signals transmitted by the notification module, received and identified by a radio frequency receiver operated by the human operator and providing direction and/or coordinates information about the location of the storage cartridge.

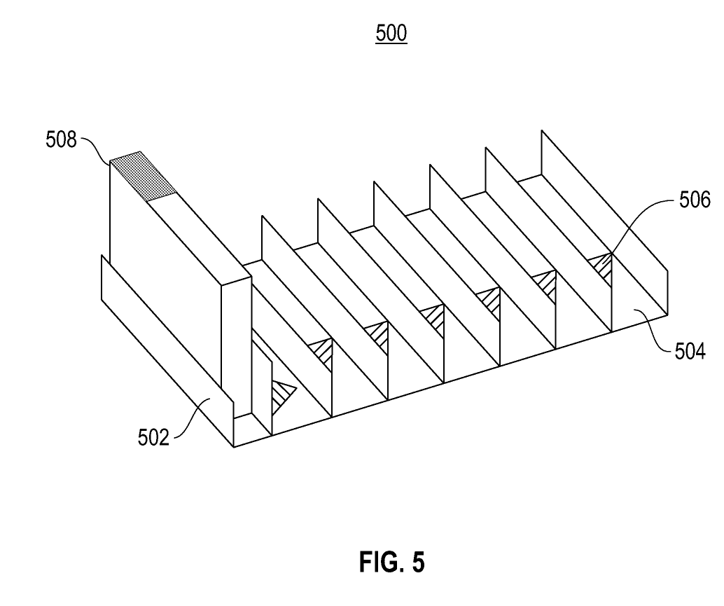

FIG. 5 illustrates a storage cartridge repository 500 for storing a self-describing storage cartridge, according to one embodiment. The storage cartridge repository 500 is embodied in a storage cartridge compartment 502, according to a preferred embodiment. The storage cartridge compartment 502 is a container configured to store a plurality of storage cartridges 508 in a plurality of storage cartridge slots 504. The storage cartridge compartment 502 may be sealed with a lid to protect storage cartridges, according to the preferred embodiment. While eight slots are illustrated, the storage cartridge repository may comprise 1 to “n” number of sleeves, where “n” equals any desired number of slots. The storage cartridge compartment includes 10 sleeves, according to a preferred embodiment. The storage cartridge compartment 502 includes a connector 506 coupled to the storage cartridge compartment 502. The connector 506 is configured to allow communication between the storage cartridge compartment 502 and the second storage module 104 of a storage cartridge 508. The connector is further configured to provide power to the second storage module 104.

The storage cartridge repository 500 may be embodied in a robotic-operated automated library according to another embodiment. An automated library is a storage cartridge storage device which contains one or more storage cartridges, a number of slots to hold the storage cartridges and drives to mount the storage cartridges 10. A robot-operated automated library mechanically moves storage cartridges from storage locations inside the library to device drives.

Indexed information may be collected from new storage cartridges as the storage cartridges are placed in a storage cartridge repository 500 and stored in a storage management database. The indexed information may be removed from the storage management database when a storage cartridge is removed from the storage cartridge repository 500 or marked as absent as long as the storage cartridge is not present.

The storage cartridge repository 502 may be visible over a network as a network storage device, according to one embodiment. The storage cartridge repository 500 may be illustrated over a network as a storage area network (SAN) device. The storage cartridge repository 502 may be further illustrated over a network as a network attached storage (NAS) device. The storage cartridge repository further includes a microcomputer device to construct a unified file and data index comprising of all the indexes of all the storage cartridges stored by the storage cartridge repository 502, according to one embodiment. The microcomputer device is further configured to communicate the unified index to other devices on the network. The microcomputer device is further configured to control the communication between the repository and the plurality of storage cartridges stored in it.

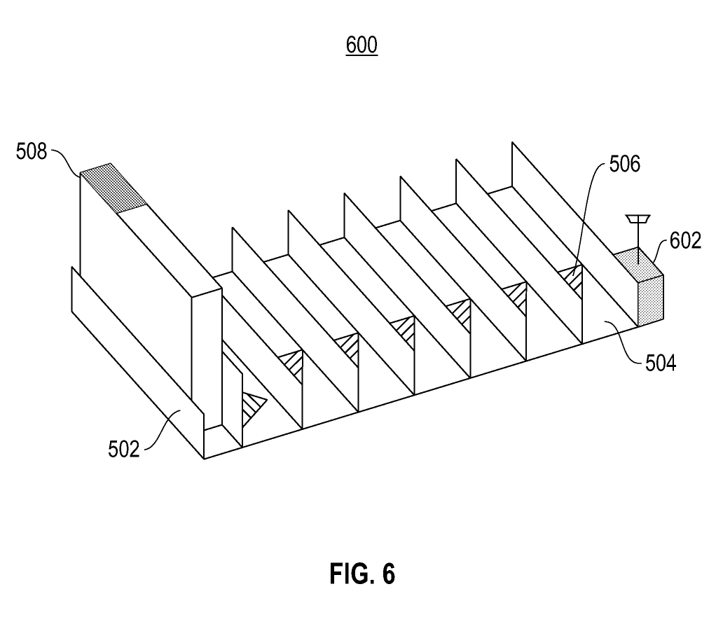

FIG. 6 illustrates a storage cartridge repository 502 with a communication module 602 for storing a self-describing storage cartridge 508, according to the preferred embodiment. The communication module 602 is configured to provide a plurality of devices with remote access to a second storage module of storage cartridge 508. The communication module 602 is further configured to provide a plurality of devices with remote access to storage cartridge repository 502.

The communication module 602 of the storage cartridge repository 502 may include a plurality of communication devices. The communication module 602 of the storage cartridge repository 502 is a wireless local area network communication module, according to a preferred embodiment. The communication module 602 of the storage cartridge repository 502 may further include a radio-frequency communication module, according to one embodiment. The communication module 602 of the storage cartridge repository 502 may further include a Bluetooth communication module, according to one embodiment. The communication module 602 of the storage cartridge repository 502 may further include a capacitive communication module, according to another embodiment.

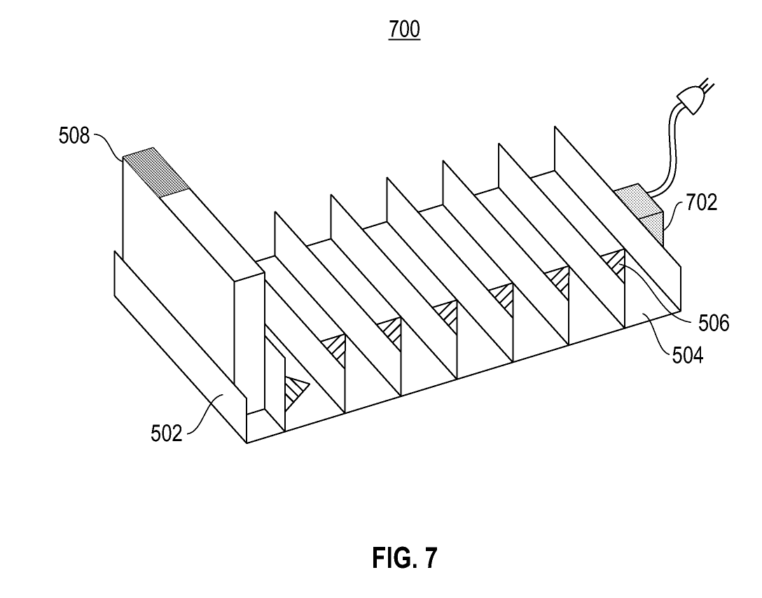

FIG. 7 illustrates a storage cartridge repository 502 with a power module 702 for storing a self-describing storage cartridge 508, according to preferred embodiment. The power module 702 is coupled to the storage cartridge repository 502. The power module 702 is embodied in an externally powered power module 702, according to a preferred embodiment. The power module 702 may be embodied in a battery powered power module, according to another embodiment.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A system for storing and locating a self-describing storage cartridge, comprising:
a storage cartridge, wherein the storage cartridge comprises:
a first storage module configured to store a plurality of data objects, and
a second storage module configured to store an index of the plurality of data objects stored on the first storage module; and
a connector coupled to the second storage module and configured to provide an external device with access to the second storage module.

2. The system of claim 1, wherein the storage cartridge further comprises:
a communication module coupled to the second storage module and configured to provide at least one external device with access to the second storage module.

3. The system of claim 1, wherein the storage cartridge further comprises:
a notification module configured to notify a location of the storage cartridge.

4. The system of claim 1, wherein the second storage module comprises a nonvolatile memory module.

5. The system of claim 1, further comprising:
a storage cartridge repository, wherein the storage cartridge repository comprises:
at least one storage slot configured to store the storage cartridge, and
a connector configured to connect the storage cartridge to the storage cartridge repository for providing the storage cartridge repository with access to the second storage module.

6. The system of claim 3, wherein the notification is a signal selected from the group consisting of:
an audible signal, and
a visual signal.

7. The system of claim 5, further comprising:
a communication module coupled to the storage cartridge repository and configured to provide at least one external device with access to the storage cartridge repository.

8. The system of claim 5, further comprising:
a power module coupled to the storage cartridge repository and configured to provide the storage cartridge repository with power.

9. The system of claim 5, further comprising:
a microcomputer device coupled to the storage cartridge repository and configured to construct a unified index comprising all indexes of storage cartridges stored in the storage cartridge repository and to provide access to the unified index.

10. The system of claim 7, wherein the communication module is further configured to provide a location of the storage cartridge on a remote display interface.

11. The system of claim 7, wherein the communication module coupled to the storage cartridge repository is further configured to provide the storage cartridge repository with remote access to the second storage module of a storage cartridge not stored in the storage cartridge repository.

12. A method for storing and locating a self-describing storage cartridge, comprising:
storing a plurality of data objects on a first storage module of a storage cartridge;
storing an index of the plurality of data objects on a second storage module of the storage cartridge; and
providing a remote device with access to the second storage module.

13. The method of claim 12, further comprising:
providing at least one external device with access to the second storage media module.

14. The method of claim 12, further comprising:
providing a notification of a location of the storage cartridge.

15. The method of claim 12, wherein the second storage module comprises a nonvolatile memory module.

16. The method of claim 12, further comprising:
storing the storage cartridge in a storage cartridge repository; and
providing the storage cartridge repository with access to the second storage module.

17. The method of claim 14, wherein providing the notification of the location of the storage cartridge generates a signal selected from the group consisting of:
an audible signal, and
a visual signal.

18. The method of claim 16, further comprising:
displaying a location of the storage cartridge on a remote interface.

19. The method of claim 16, further comprising:
providing an external device with access to the storage cartridge repository.

20. The method of claim 16, further comprising:
accessing the second storage module with at least one external device.
